(19) United States
(12) Patent Application Publication
(10) Pub. No.: US 2025/0163889 A1
(43) Pub. Date: May 22, 2025

(54) SYSTEM AND METHOD FOR ASSESSING AND OPTIMIZING WIND FARMS USING MACHINE LEARNING

(71) Applicant: SHELL USA, INC., Houston, TX (US)

(72) Inventors: Balakrishnan Bhaskaran, London (GB); Simon Warder, Letchworth Garden City (GB); Matthew Piggott, London (GB)

(21) Appl. No.: 18/512,115

(22) Filed: Nov. 17, 2023

(51) Int. Cl. F03D 7/04

(52) U.S. Cl. CPC F03D 7/046; F03D 7/048; F05B 2270/32; F05B 2270/709

(57) ABSTRACT

A computing system identifies a geographical region of interest. The computing system generates a background numerical weather prediction using a mesoscale numerical weather prediction model. The computing system identifies information associated with wind farms for inclusion in the geographical region of interest. For each wind farm, the computing system determines a wake effect of neighboring farms to the first wind farm by projecting wind deficits for the neighboring farms to generate a plurality of wake effects for the geographical region. The computing system generates an estimated power output for the wind farms in the geographical region of interest based on the plurality of wake effects.

### FIELD OF DISCLOSURE

Embodiments disclosed herein generally relate to systems and methods for predicting inter-farm wakes in real-world weather conditions.

### BACKGROUND

The build out of wind farms, such as wind farms in the North Sea, is expected to accelerate over the next few decades to meet climate goals. In 2019, for example, Europe's total offshore wind installed capacity exceeded 22 GW, with 77% of this capacity in the North Sea. Meanwhile, the EU has set a target of 60 GW of installed offshore wind by 2030, and 300 GW by 2050. New offshore wind development is expected to reach around 30 GW per year in Europe, and 55 GW globally by 2031.

### SUMMARY

In some embodiments, a method is disclosed herein. A computing system identifies a geographical region of interest. The computing system generates a background numerical weather prediction using a mesoscale numerical weather prediction model. The background numerical weather prediction illustrates a weather prediction for the geographical region of interest without any wind farms. The computing system identifies information associated with wind farms for inclusion in the geographical region of interest. The information includes coordinates associated each wind farm and turbine information associated with each wind farm. For each wind farm, the computing system determines a wake effect of neighboring farms to the wind farm by projecting wind deficits for the neighboring farms to generate a plurality of wake effects for the geographical region. The computing system generates an estimated power output for the geographical region of interest based on the plurality of wake effects.

In some embodiments, a non-transitory computer readable medium is disclosed herein. The non-transitory computer readable medium includes one or more sequences of instructions, which, when executed by a processor, causes a computing system to perform operations. The operations include identifying, by the computing system, a geographical region of interest. The operations further include generating, by the computing system, a background numerical weather prediction using a mesoscale numerical weather prediction model. The background numerical weather prediction illustrates a weather prediction for the geographical region of interest without any wind farms. The operations further include identifying, by the computing system, information associated with wind farms for inclusion in the geographical region of interest. The information includes coordinates associated each wind farm and turbine information associated with each wind farm. For each wind farm, the computing system determines a wake effect of neighboring farms to the wind farm by projecting wind deficits for the neighboring farms to generate a plurality of wake effects for the geographical region. The operations further include generating, by the computing system, an estimated power output for the geographical region of interest based on the plurality of wake effects.

In some embodiments, a system is disclosed herein. The system includes a processor and a memory. The memory has programming instructions stored thereon, which, when executed by the processor, causes the system to perform operations. The operations include identifying a geographical region of interest. The operations further include generating a background numerical weather prediction using a mesoscale numerical weather prediction model. The background numerical weather prediction illustrates a weather prediction for the geographical region of interest without any wind farms. The operations further include identifying information associated with wind farms for inclusion in the geographical region of interest. The information includes coordinates associated each wind farm and turbine information associated with each wind farm. The operations further include, for each wind farm, determining a wake effect of neighboring farms to the wind farm by projecting wind deficits for the neighboring farms to generate a plurality of wake effects for the geographical region. The operations further include generating an estimated power output for the geographical region of interest based on the plurality of wake effects.

### BRIEF DESCRIPTION OF THE FIGURES

The accompanying drawings, which are incorporated herein and form part of the specification, illustrate the present disclosure and, together with the description, further serve to explain the principles of the present disclosure and to enable a person skilled in the relevant art(s) to make and use embodiments described herein.

FIG. 1 is a block diagram illustrating a diagnostic environment, according to example embodiments.

FIG. 2 is a block diagram illustrating a plurality of build-out stages for a given region, according to example embodiments.

FIG. 3 is a block diagram illustrating a computing system, according to example embodiments.

FIG. 4 is a block diagram illustrating an exemplary workflow, according to example embodiments.

FIG. 5 is a block diagram illustrating the pairwise percentage loss between individual pairs of farms at various stages, according to example embodiments.

FIG. 6 is a flow diagram illustrating a method of predicting inter-farm wakes for a wind field, according to example embodiments.

FIG. 7A is a block diagram illustrating a computing device, according to example embodiments of the present disclosure.

FIG. 7B is a block diagram illustrating a computing device, according to example embodiments of the present disclosure.

The features of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

Inter-farm wake effects are known to reduce wind farm energy yields, leading to increased costs. These wakes arise due to the removal of kinetic energy from the atmosphere by wind turbines. Wind farm wakes have been observed to persist 10s of km downstream of offshore wind farms, depending on a variety of factors including wind speed and atmospheric stratification. Within existing installations, wind farm wakes have been estimated to induce up to a 12% reduction in the power available at nearby farms, while losses of up to one third have been estimated for a hypothetical future scenario. Inter-farm interactions have implications on a variety of industry and governmental needs, including the optimal design of individual farms, short to medium-term power predictions, such as for load balancing purposes or day-ahead energy markets, and at a larger (e.g., regional/multi-decadal) scale for planning future wind farm build-out.

Future economic losses due to large-scale farm deployment are dependent on the build-out trajectory, with a number of studies highlighting this issue and suggesting that future build-out should be coordinated across developers and countries. There is also a lack of legal structure in place for protecting wind farm developers from adverse wake effects impacting their farms. The need to consider inter-farm interactions will likely increase in the future, given planned installations.

Despite the consensus on the need for coordinated build-out, to date, there has been a lack of tools well suited to wind farm spatial planning. One or more techniques disclosed herein describe a novel machine-learning based approach for predicting inter-farm wakes in real-world weather conditions. Such approaches utilize a background (e.g., farm free) numerical weather prediction simulation that may be performed for each time period of interest. Once the numerical weather prediction simulation is generated, the present approach utilizes a machine learning model, such as a neural network, to predict the wakes from wind farms placed within the background wind field. The power production of farms within a wake-affected wind field can then be predicted. By using only one farm-free numerical weather prediction, the present framework drastically reduces the computational cost associated with assessing multiple build-out scenarios/stages, varying farm locations or array configurations, while taking account of inter-farm wake effects.

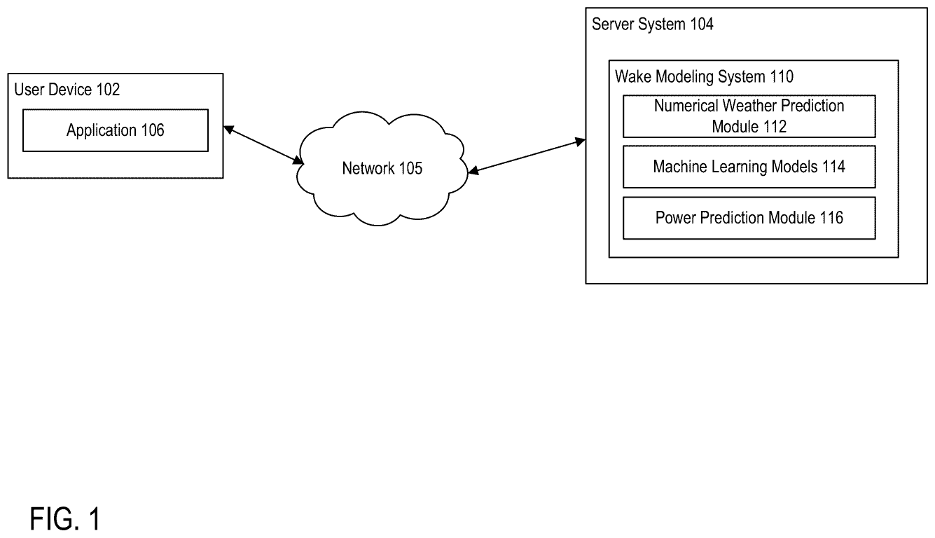

FIG. 1 is a block diagram illustrating an exemplary computing environment 100, according to example embodiments. Computing environment 100 may include user device 102 and server system 104 communicating via network 105.

Network 105 may be representative of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data. For example, network 105 may be representative of the Internet, a private data network, virtual private network using a public network and/or other suitable connection(s) that enables components in computing environment 100 to send and receive information between the components of computing environment 100.

User device 102 may be operated by a user. In some embodiments, user device 102 may represent devices of users that are associated with or subscribed to services offered by an entity associated with server system 104. In some embodiments, user device 102 may be representative of one or more computing devices, such as, but not limited to, a mobile device, a tablet, a personal computer, a laptop, a desktop computer, or, more generally, any computing device or system having the capabilities described herein.

User device 102 may include application 106. Application 106 may be representative of a web browser that allows access to a website or a stand-alone application. User device 102 may access application 106 to access one or more functionalities of server system 104. User device 102 may communicate over network 105 to request a webpage, for example, from a web client application server of server system 104. In some embodiments, a user of user device 102 may execute application 106 to train machine learning models hosted by server system 104. In some embodiments, a user of user device 102 may execute application 106 for accessing functionality of the trained machine learning models.

Server system 104 may be configured to host wake modeling system 110. Wake modeling system 110 may be configured to predict inter-farm wakes in real-world weather conditions. As shown, wake modeling system 110 may include a mesoscale numerical weather prediction module 112, a machine learning model 114, and a power prediction module 116. Each of numerical weather prediction module 112 and power prediction module 116 may include one or more software modules. The one or more software modules can be collections of code or instructions stored on a media (e.g., memory of server system 104) that represent a series of machine instructions (e.g., program code) that implement one or more algorithmic steps. Such machine instructions may be the actual computer code the processor of server system 104 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

Numerical weather prediction module 112 may include a mesoscale numerical weather prediction model that may be implemented to generate a background numerical weather prediction simulation for an area and/or time period of interest. In some embodiments, the mesoscale numerical weather prediction model utilized by numerical weather prediction module 112 may be the Weather Research and Forecasting (WRF) model.

As those skilled in the art understand, mesoscale numerical weather prediction models, such as the WRF model, have been used for the assessment of inter-farm wake interactions. However, the computational cost associated with mesoscale numerical weather prediction models is a barrier to the assessment of build-out scenarios on regional and decadal scales. Instead, most numerical studies of inter-farm wake effects are limited to small spatial scales and/or the selection of a small number of weather conditions.

Rather than leverage numerical weather prediction module 112 to generate various what-if scenarios for various build-out scenarios for a wind farm region, to lower the overall cost and computational requirements of server system 104, numerical weather prediction module 112 may instead be utilized to generate a background numerical weather prediction simulation. In this manner, wake modeling system 110 may utilize numerical weather prediction for a single region, while relying on machine learning models 114 for generating various what-if scenarios for various build-out scenarios for a given wind farm region.

Machine learning models 114 may be configured to predict wakes from wind farms placed within a wind farm region, such as the wind farm region for which numerical weather prediction module 112 generated the background numerical weather prediction. By utilizing only one farm-free numerical weather prediction, wake modeling system 110 provides an improvement over conventional approaches to assessing inter-farm wake interactions by reducing the computational overhead and thus reducing the costs associated with such analyses. Machine learning models 114 can analyze several build-out scenarios for a wind farm region based on the same background numerical weather prediction generated by numerical weather prediction module 112.

In some embodiments, such as when a given region includes multiple farms within a region, wake modeling system 110 may implement a machine learning model 114 for each farm. For example, assume there are n farms within a region. Numerical weather prediction module 112 may first generate background information for the region by performing a numerical weather prediction simulation for an area and/or time period of interest. Given the background information, for a given farm, e.g., farm 1, wake modeling system 110 may deploy a series of machine learning models 114 for each of farms 2 through n. As output, each machine learning model 114 may generate a wake deficit for that farm. The wake deficit fields predicted by wake modeling system 110 may then be superposed with the background information to produce a wake-affected wind field for farm 1. For example, the wake deficit d may be defined as:

$$d = \frac{\vert {u}_{f} \vert - \vert {u}_{b g} \vert}{\vert {u}_{b g} \vert} \qquad ( 1 )$$

where u_{bg} may represent the two-dimensional background horizontal field with no farms present, as generated by numerical weather prediction module 112, and u_{f} represents the velocity field with a wind farm.

Power prediction module 116 may be configured to determine the power output of a farm. In some embodiments, power prediction module 116 may determine the power output of the farm based on the predicted velocity field of the wind farm and farm turbine data. For example, since power prediction typically relies on the wind velocities to be closest to the relevant turbine height, wake modeling system 110 may compute deficit fields for the vertical levels closest to each hub height. Based on the actual information of the turbine, power prediction module 116 may apply the wind velocities to the power curve corresponding to the correct turbine height. Such process may generate a predicted farm power.

Accordingly, based on the output from power prediction module 116, wake modeling system 110 can estimate a power loss at a given wind farm due to inter-farm wake effects.

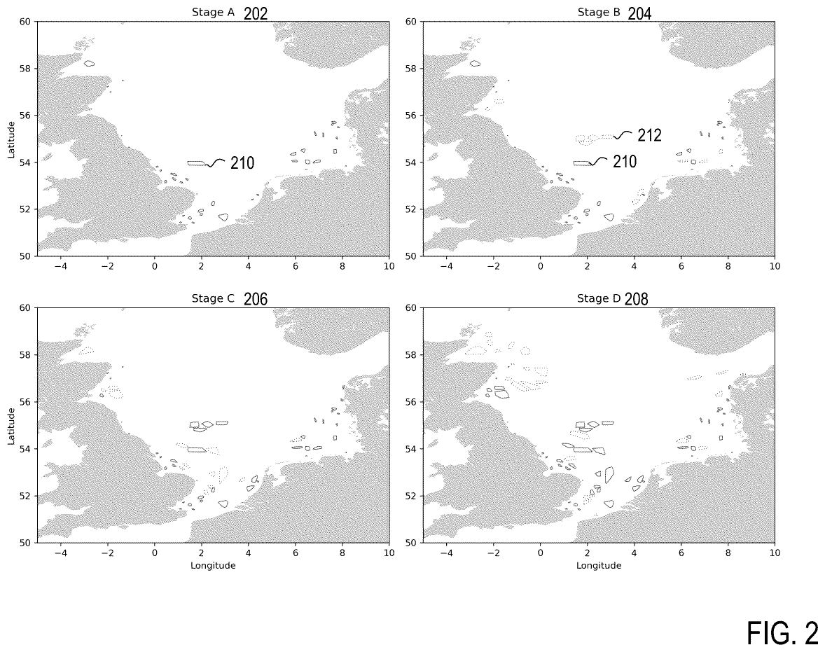

FIG. 2 is a block diagram illustrating a plurality of build-out stages for a given region, according to example embodiments. As shown, FIG. 2 illustrates four build-out stages: Stage A 202, Stage B 204, Stage C 206, and Stage D 208. Each of Stage A through Stage D represents a given build-out stage of a wind farm region. The solid shapes (e.g., 210) may represent wind farms or lease areas that are unchanged from the previous build-out stage; dashed shapes (e.g., 212) may represent newly added farms or those extended compared to previous stages.

Each stage may include all farms from the previous region, such as but not limited to, fully commissioned farms, partial generation or under construction farms, consent authorized or application submitted farms, and/or concepted/early planning farms.

As stated above, to generate power loss for any given stage (e.g., Stages A-D), wake modeling system 110 may only generate one numerical weather prediction for the background. Wake modeling system 110 may then deploy machine learning models 114 for each scenario represented in Stages A-D.

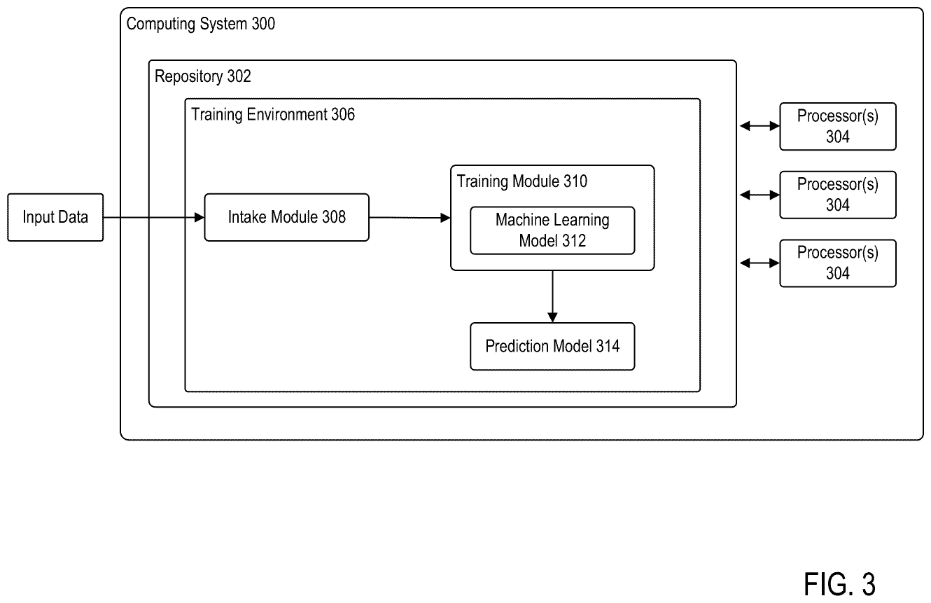

FIG. 3 is a block diagram illustrating computing system 300, according to example embodiments. As shown, FIG. 3 may represent a training environment in which machine learning models 114 may be trained to predict wakes from wind farms placed within a wind farm region. Computing system 300 may include a repository 302 and one or more computer processors 304.

Repository 302 may be representative of any type of storage unit and/or device (e.g., a file system, database, collection of tables, or any other storage mechanism) for storing data. Further, repository 302 may include multiple different storage units and/or devices. The multiple different storage units and/or devices may or may not be of the same type or located at the same physical site. As shown, repository 302 includes at least a training environment 306. Training environment 306 may represent a computing environment in which one or more machine learning models may be trained to predict wakes from wind farms placed within a given wind farm region.

Training environment 306 may include one or more of intake module 308 and training module 310. Each of intake module 308 and training module 310 may include one or more software modules. The one or more software modules can be collections of code or instructions stored on a media (e.g., memory of computing system 300) that represent a series of machine instructions (e.g., program code) that implements one or more algorithmic steps. Such machine instructions may be the actual computer code the processor of computing system 300 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

Intake module 308 may be configured to receive data for training. In some embodiments, the training data may be generated in the form of a pair of model runs, i.e., a first model run with a wind farm and a second model run without a wind farm. These model runs may provide the background wind fields at one or more timestamps, as well as additional fields such as the turbulent kinetic energy and the wake deficit field at the final time stamp. Intake module 308 may form a training data set using this data, along with the turbine layout, as the input and target output for training the machine learning model.

In some embodiments, the data for training may be selected from a set of wind farms and weather conditions. For example, the training data may be derived from all farms from various build-out stages. For each farm, intake module 308 may identify a subset of weather snapshots, which may capture the full range of wind speed and direction experienced at its location. For example, the training data set may be based on ERA-5 wind velocities at each farm. From this data, in some embodiments, intake module 308 may bin the wind conditions at each farm location into one or more speed bins and one or more wind direction bins. In some embodiments, intake module 308 may randomly select one or more samples from each bin to include in the training data set. At most farm locations, there are some combinations of wind speed and direction (e.g., high speeds opposing the prevailing wind direction) for which there may be no samples falling within the relevant bin. For each sample, intake module 308 may utilize numerical weather prediction module 112 to run a numerical weather prediction simulation using a domain configuration where the nested domain spans only 400 km on each side, with the farm at its center. In some embodiments, once intake module 308 generates the training data, intake module 308 may further augment the dataset by reflecting each training sample in a line passing through the wind farm and aligned with the wind direction at the farm. Such process may result in physically plausible wind fields and wakes, while still having the wake aligned with the x-axis. The purpose of this process is to generate additional training samples, without incurring the computational cost of running additional pairs of WRF runs.

Training module 310 may be configured to train machine learning model 312 using the training data set. For example, training module 310 may train machine learning model 312 to predict the wake deficit field induced by a wind farm, given the background wind conditions. The wake deficit field is defined above in Equation 1.

In some embodiments, training module 310 may train machine learning model 312 to predict wake deficit fields, which have been projected onto the standard grid via rotation and cropping such that the wind farm centroid is at coordinates x=0, y=0, and the wake is aligned with the positive x-axis. In some embodiments, intake module 308 may apply the same rotation and cropping to the training data set. The rotation may be based on the background wind direction at the farm location at the final simulation time stamp and, hence, may not utilize any information about the wake itself. Such pre-processing step may simplify the wake prediction problem by using a priori knowledge that wakes form in the downstream direction. Predicted deficit fields may then be mapped back onto the original model grid by padding with zeroes and rotation (i.e., the inverse of the rotation and cropping pre-processing step).

In some embodiments, training module may use a mean squared error loss function to train machine learning model 312. The mean squared error loss function may be given by:

$$Loss = \frac{1}{L \times M \times N} {\sum }_{m = 1}^{M} {\sum }_{n = 1}^{N} {\sum }_{l = 1}^{L} [ {( {d}_{m n l} - )}^{2} ] \qquad ( 2 )$$

where L may be representative of the number of vertical levels, M and N may be representative of the horizontal extents of the standard wake grid, dₘₙₗ and [symbol] may be representative of the predicted and numerical weather prediction-derived wake deficit tensors.

In some embodiments, spurious effects at the edge of the standard grid may be mitigated by cropping the outermost pixels on each side. In some embodiments, training module 310 may utilize an Adam optimizer for network training.

In some embodiments, machine learning model 312 may be representative of a neural network. For example, machine learning model 312 may be representative of a U-net architecture. The U-net architecture includes convolutional layers which are capable of taking advantage of the structured grid onto which the input wind fields have been transformed.

Following training, training module 310 may output a fully trained model-prediction model 314. In some embodiments, prediction model 314 may be loaded onto a GPU for inference.

In some embodiments, the layers of prediction model 314 may correspond to physical fields extracted from the background numerical weather prediction simulation and projected onto the standard grid. The physical fields may correspond to the u, v and turbulent kinetic energy fields at various vertical levels and timestamps from the numerical simulation. In some embodiments, further input layers may encode the number of turbines within each transformed grid cell, for each of a pre-selected set of turbine types (e.g., one layer per turbine type). In some embodiments, the input data may be represented as a tensor. The input data may be further normalized on a per-layer basis to the range of 0-1. Output from prediction model 314 may be the velocity deficit field at the final simulation t as defined by Equation 1, at each of the selected vertical levels. Such output may be represented as a tensor, 0-1.

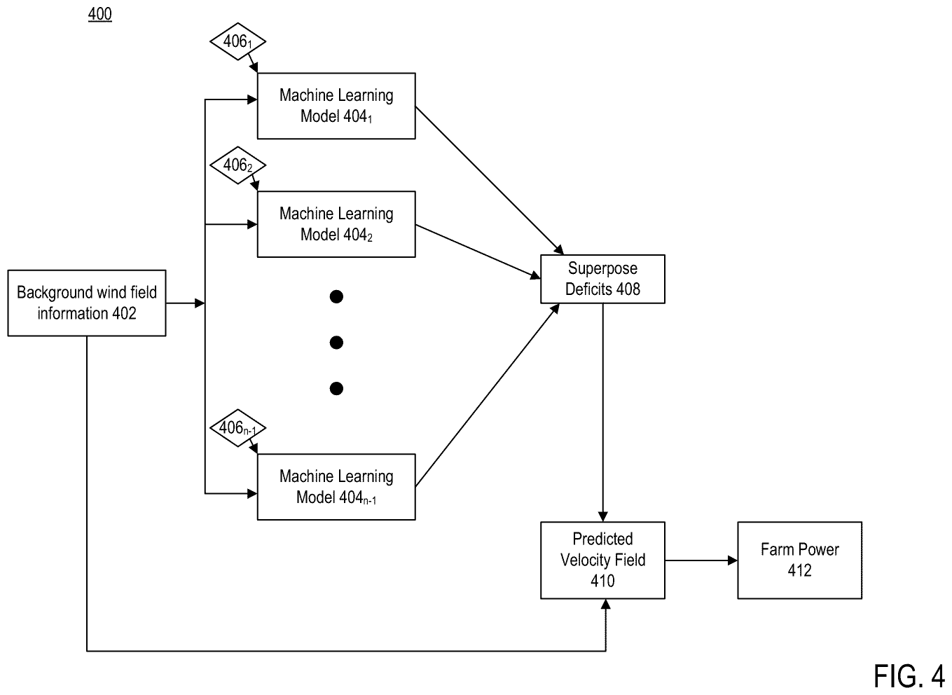

FIG. 4 is a block diagram illustrating an exemplary workflow 400 for generating a predicted wind farm power for a region of interest, according to example embodiments.

As shown, workflow 400 may begin with background wind field information 402 for a region of interest. For example, numerical weather prediction module 112 may run a numerical weather prediction simulation on the region of interest to generate background wind field information 402. The simulation may represent the region of interest without any wind farms.

Background wind field information 402 may then be used by a plurality of machine learning models 404₁ to 404ₙ₋₁ (generally “machine learning model 404” or “machine learning models 404”) to predict wakes from wind farms placed in the background wind field. For example, assume that there are n wind farms to be placed in the background wind field. Each wind farm may have an instance of machine learning model 404 associated therewith. To predict wakes for the neighbors of a given wind farm, such as wind farm n, machine learning models 404 corresponding to all the wind farms, with the exception of wind farm n may be used. Accordingly, FIG. 4 only shows machine learning models 404₁ to 404ₙ₋₁. The process may be repeated for all wind farm 1 . . . n by omitting the machine learning model corresponding to the wind farm of interest. So, for example, to predict the wakes from the neighbors of wind farm 1, machine learning models 404₂ to 404ₙ₋₁ may be used.

As shown, each machine learning model 404 may receive, as input, the background wind field information generated by numerical weather prediction module 112 and farm turbine data 406₁-406ₙ₋₁ (generally “farm turbine data 406”) associated with the wind turbine corresponding to a given machine learning model 404. Based on the input information, machine learning model 404 may generate, as output, wind deficits corresponding to the neighbors of the wind farm of interest. Continuing with the above example for predicting the wakes from wind farm 1, machine learning model 404₂ may receive, as input, background wind field information 402 and farm turbine data 406₂ associated with wind turbine 2; machine learning model 404₃ may receive, as input, background wind field information 402 and farm turbine data 406₃ associated with wind turbine 3; and, more generally, machine learning model 404ₙ₋₁ may receive, as input, background wind field information 402 and farm turbine data 406ₙ₋₁ associated with wind turbine n−1.

Once the wind deficits corresponding to each neighboring wind farm are generated, the wind deficits may be superposed to generate superposed deficits 408. In some embodiments, the superposed deficits 408 may be used to generate a predicted velocity field 410 for the region of interest. This may be calculated via Equation 1, where d is replaced with the superposed deficits 408. Predicted velocity field 410 may then be used as input to a farm scale model to estimate the power output of a wind farm (e.g., predicted farm power 412). The power output from a given turbine can be estimated from the wind speed at its location, via a power curve which gives the relationship between wind speed and power output for a particular turbine. In some embodiments, the prediction of total farm power may involve applying turbine power curves to predicted velocity field 410 to estimate the power output at each turbine, and summing over the turbines present in each farm. In some embodiments, other possible methods, such as but not limited to, existing farm-scale models (PyWake, FLORIS) may be used to estimate the power output at each turbine. The approach taken may be developer or user specific.

The same process may be repeated for each wind farm 1 . . . n. One of the benefits of the above approach is that, although multiple what-if scenarios may be generated for a given region, only a single numerical weather prediction simulation needs to be generated. As such, the present approach provides a much more flexible approach to determining predicted farm power compared to conventional approaches.

Accordingly, based on the various stages shown in FIG. 2 above, for example, workflow 400 may be employed to estimate the mean power output from each farm. Such process may be performed with and without inter-farm wakes and thus can estimate the power loses due to the wakes and compare these losses between build-out stages.

Furthermore, due to the low computational cost associated with considering different build-out scenarios via machine learning model framework, individual farms may be toggled on and off. In this manner, an end user may observe the resulting changes in power at other nearby farms. In this manner, wake modeling system 110 may be used to attribute wake-induced losses at a given farm to each of its neighbors. As a metric summarizing the interaction between a given pair of farms, a pairwise percentage loss (PPL) may be defined as the total inter-farm wake-induced losses inflicted by the pair of farms on each other, as a percentage of their combined installed capacity.

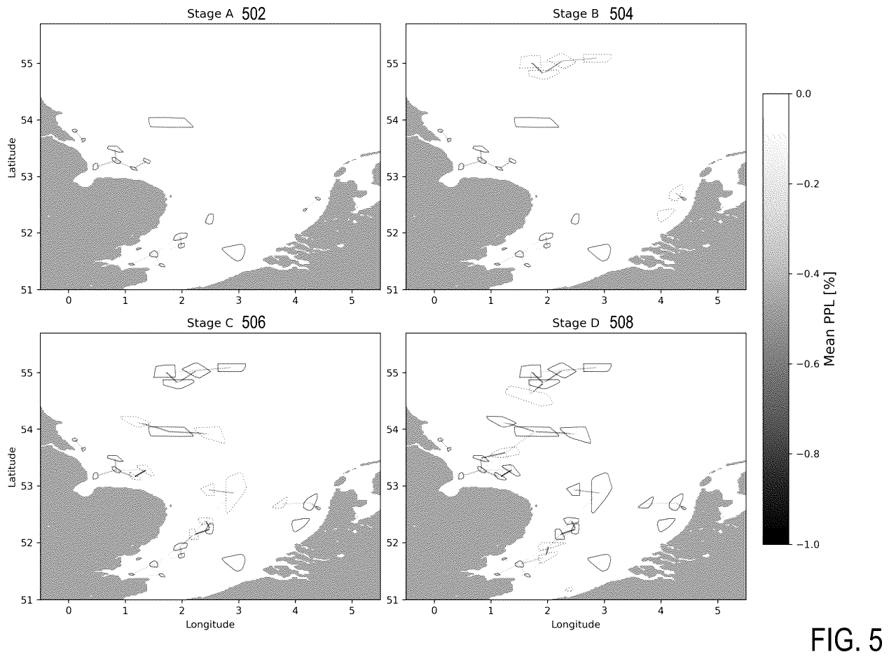

FIG. 5 is a block diagram illustrating the PPL between individual pairs of farms at various stages, according to example embodiments. As shown, FIG. 5 illustrates four stages: Stage A 502, Stage B 504, Stage C 506, and Stage D 508. At Stage A 502 and Stage B 504, the interactions may create small clusters of inter-connected farms. In these scenarios, it may be appropriate to consider the problem of spatial wind farm planning as series of disconnected smaller-scale problems. However, as shown in Stage C 506 and Stage D 508, as more farms are built, the cluster may expand and become connected. By Stage D 508, disconnected clusters may arise, but at larger spatial scales. Accordingly, FIG. 5 may illustrate that with future build-out, it may not be possible to consider small regions in isolation; thus, the optimization of resource extraction may become an increasingly complex problem involving more farms and larger spatial scales.

In some embodiments, PPL may also be used to investigate the factors that may give rise to the greatest wake-induced losses. Losses may decrease rapidly as separation distance increases and are approximately zero for separation distances in excess of a threshold distance (e.g., 50 km). PPL may also depend on the separation angle between two farms. For example, farms which may be arranged such that one farm lies downstream of another during prevailing wind conditions (i.e., a separation angle with respect to the prevailing wind of zero) may incur greater losses than those arranged perpendicular to the prevailing wind.

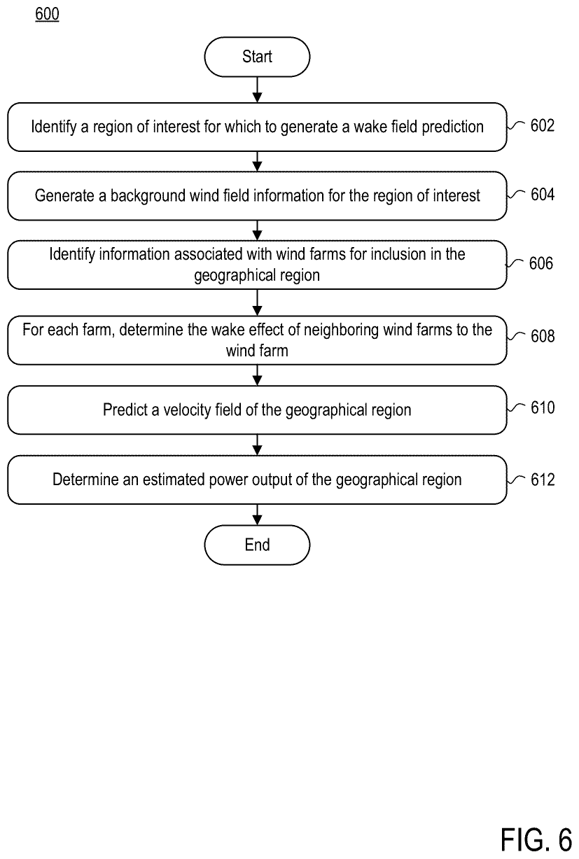

FIG. 6 is a flow diagram illustrating a method 600 of predicting the total power output of a set of wind farms, for a given wind field, according to example embodiments. Method 600 may start at step 602.

At step 602, wake modeling system 110 may identify a region of interest for which to generate a wind field prediction. In some embodiments, wake modeling system 110 may receive the region of interest via application 106 executing on user device 102.

At step 604, wake modeling system 110 may first generate a background wind field information for the region of interest. In some embodiments, numerical weather prediction module 112 may generate the background wind field information utilizing a mesoscale numerical weather prediction model for the region of interest. In some embodiments, the mesoscale numerical weather prediction model utilized by numerical weather prediction module 112 may be the WRF model.

At step 606, wake modeling system 110 may identify information associated with wind farms for inclusion in the geographical region. For example, wake modeling system 110 may receive, as input, information related to existing wind farms in the region of interest and/or proposed wind farms in the region of interest. In some embodiments, wake modeling system 110 may further receive parameters associated with the wind turbines for each wind farm. Exemplary parameters may include, but are not limited to, turbine height, rotor diameter and nominal power, and the farm size, shape, position, turbine density and layout.

At step 608, for each wind farm, wake modeling system 110 may determine the wake effect of neighboring wind farms to the given wind farm. For example, wake modeling system 110 may employ a series of machine learning models 114. Each machine learning model 114 may correspond to a given wind farm. To determine the wake effect of neighboring wind farms to a first wind farm, wake modeling system 110 may utilize the machine learning models 114 for all wind farms but the first wind farm. Each machine learning model 114 may receive, as input, the background wind field information generated by numerical weather prediction module 112 and farm turbine data associated with the wind turbine corresponding to a given machine learning model 114. Based on the input information, machine learning models 114 may generate, as output, wind deficits corresponding to the neighbors of the wind farm of interest. The wind deficits of the neighboring wind farms may be superposed to generate a wind deficit for the farm of interest. Accordingly, step 608 may yield a plurality of wind deficits for the plurality of wind farms.

At step 610, wake modeling system 110 may predict the velocity field of the geographical region. For example, wake modeling system 110 may predict a velocity field by combining the superposed deficits with the background numerical simulation.

At step 612, wake modeling system 110 may determine the estimated power output of the geographical region. For example, power prediction module 116 may generate the power output of the wind farm layout based on the predicted velocity field generated at step 610. For example, power prediction module 116 may apply turbine power curves to a velocity field of each wind farm to estimate the power output, summing over the turbines present in each farm.

As those skilled in the art understand, the foregoing process may be repeated for each of the wind farms to determine the power produced by each wind farm in the region of interest. The power produced by each farm may be summed to predict the overall power of the wind farms.

The iterative application of the procedure described above may form the basis of an optimization of the layout of wind farms within the region, such that an objective function, which may be related to the total power output, is maximized, subject to other constraints which may be provided by the user.

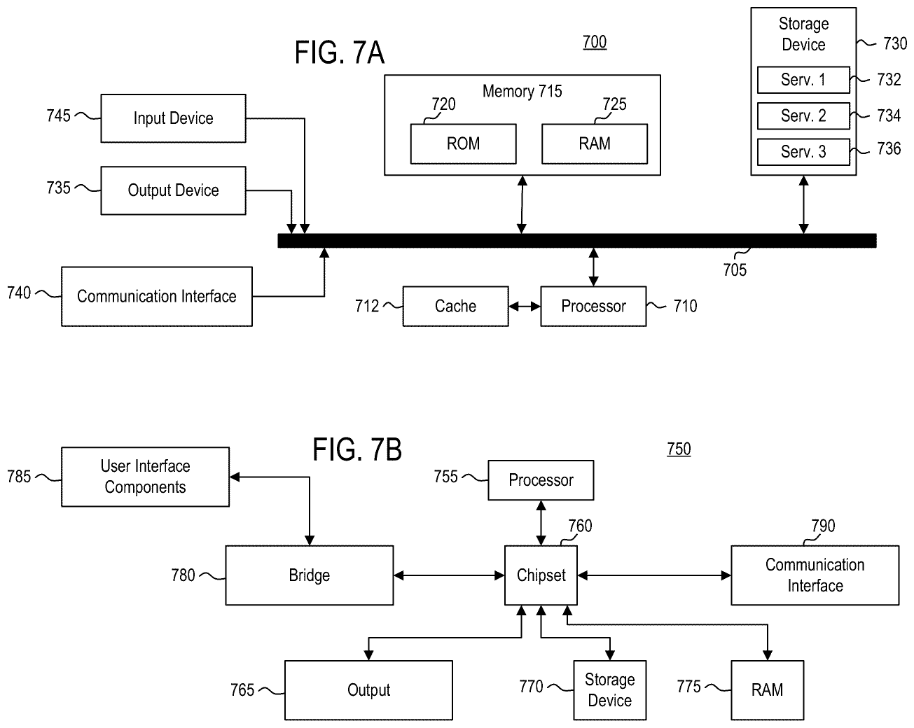

FIG. 7A illustrates a system bus architecture of computing system 700, according to example embodiments. System 700 may be representative of at least server system 104. One or more components of system 700 may be in electrical communication with each other using a bus 705. System 700 may include a processing unit (CPU or processor) 710 and a system bus 705 that couples various system components including the system memory 715, such as read only memory (ROM) 720 and random-access memory (RAM) 725, to processor 710.

System 700 may include a cache of high-speed memory connected directly with, in close proximity to, or integrated as part of processor 710. System 700 may copy data from memory 715 and/or storage device 730 to cache 712 for quick access by processor 710. In this way, cache 712 may provide a performance boost that avoids processor 710 delays while waiting for data. These and other modules may control or be configured to control processor 710 to perform various actions. Other system memory 715 may be available for use as well. Memory 715 may include multiple different types of memory with different performance characteristics. Processor 710 may include any general-purpose processor and a hardware module or software module, such as service 1 732, service 2 734, and service 3 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction with the computing system 700, an input device 745 may represent any number of input mechanisms, such as a microphone for speech, a touch-sensitive screen for gesture or graphical input, keyboard, mouse, motion input, speech, and so forth. An output device 735 may also be one or more of a number of output mechanisms known to those of skill in the art. In some instances, multimodal systems may enable a user to provide multiple types of input to communicate with computing system 700. Communications interface 740 may generally govern and manage the user input and system output. There is no restriction on operating on any particular hardware arrangement and therefore the basic features here may easily be substituted for improved hardware or firmware arrangements as they are developed.

Storage device 730 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 725, read only memory (ROM) 720, and hybrids thereof.

Storage device 730 may include services 732, 734, and 736 for controlling the processor 710. Other hardware or software modules are contemplated. Storage device 730 may be connected to system bus 705. In one aspect, a hardware module that performs a particular function may include the software component stored in a computer-readable medium in connection with the necessary hardware components, such as processor 710, bus 705, output device 735 (e.g., display), and so forth, to carry out the function.

FIG. 7B illustrates a computer system 750 having a chipset architecture that may represent at least computing system 74. Computer system 750 may be an example of computer hardware, software, and firmware that may be used to implement the disclosed technology. System 750 may include a processor 755, representative of any number of physically and/or logically distinct resources capable of executing software, firmware, and hardware configured to perform identified computations. Processor 755 may communicate with a chipset 760 that may control input to and output from processor 755.

In this example, chipset 760 outputs information to output 765, such as a display, and may read and write information to storage device 770, which may include magnetic media, and solid-state media, for example. Chipset 760 may also read data from and write data to storage device 775 (e.g., RAM). A bridge 780 for interfacing with a variety of user interface components 785 may be provided for interfacing with chipset 760. Such user interface components 785 may include a keyboard, a microphone, touch detection and processing circuitry, a pointing device, such as a mouse, and so on. In general, inputs to system 750 may come from any of a variety of sources, machine generated and/or human generated.

Chipset 760 may also interface with one or more communication interfaces 790 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 755 analyzing data stored in storage device 770 or storage device 775. Further, the machine may receive inputs from a user through user interface components 785 and execute appropriate functions, such as browsing functions by interpreting these inputs using processor 755.

It may be appreciated that example systems 700 and 750 may have more than one processor 710 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A method, comprising:
identifying, by a computing system, a geographical region of interest;
generating, by the computing system, a background numerical weather prediction using a mesoscale numerical weather prediction model, the background numerical weather prediction illustrating a weather prediction for the geographical region of interest without any wind farms;
identifying, by the computing system, information associated with wind farms for inclusion in the geographical region of interest, the information comprising coordinates associated each wind farm and turbine information associated with each wind farm;
for each wind farm, determining, by the computing system, a wake effect of neighboring farms to the wind farm by projecting wind deficits for the neighboring farms to generate a plurality of wake effects for the geographical region; and
generating, by the computing system, an estimated power output for the geographical region of interest based on the plurality of wake effects.

2. The method of claim 1, wherein the wind farms comprise existing wind farms in the geographical region of interest and proposed wind farms in the geographical region of interest.

3. The method of claim 1, wherein determining, by the computing system, the wake effect of the neighboring farms to the wind farm by projecting the wind deficits for the neighboring farms comprises:
for each neighboring farm, inputting a subset of information associated with the neighboring farm and the background numerical weather prediction into a neural network trained to generate wind deficits for the neighboring farm.

4. The method of claim 3, wherein projecting the wind deficits for the neighboring farms comprises:
superposing a plurality of wind deficits for the neighboring farms to generate a superposed wind deficit.

5. The method of claim 4, further comprising:
generating a predicted velocity field based on the superposed wind deficit.

6. The method of claim 5, wherein determining, by the computing system, the estimated power output for the wind farms in the geographical region of interest comprises:
applying turbine power curves to the predicted velocity field to generate the estimated power output.

7. The method of claim 1, wherein the information associated with the wind farms comprises one or more of height information, rotor diameter, nominal power, farm size, shape, position, turbine density and layout.

8. A non-transitory computer readable medium comprising one or more sequences of instructions, which, when executed by a processor, causes a computing system to perform operations comprising:
identifying, by the computing system, a geographical region of interest;
generating, by the computing system, a background numerical weather prediction using a mesoscale numerical weather prediction model, the background numerical weather prediction illustrating a weather prediction for the geographical region of interest without any wind farms;
identifying, by the computing system, information associated with wind farms for inclusion in the geographical region of interest, the information comprising coordinates associated each wind farm and turbine information associated with each wind farm;
for each wind farm, determining, by the computing system, a wake effect of neighboring farms to the wind farm by projecting wind deficits for the neighboring farms to generate a plurality of wake effects for the geographical region; and
generating, by the computing system, an estimated power output for the geographical region of interest based on the plurality of wake effects.

9. The non-transitory computer readable medium of claim 8, wherein the wind farms comprise existing wind farms in the geographical region of interest and proposed wind farms in the geographical region of interest.

10. The non-transitory computer readable medium of claim 8, wherein determining, by the computing system, the wake effect of the neighboring farms to the wind farm by projecting the wind deficits for the neighboring farms comprises:
for each neighboring farm, inputting a subset of information associated with the neighboring farm and the background numerical weather prediction into a neural network trained to generated wind deficits for the neighboring farm.

11. The non-transitory computer readable medium of claim 10, wherein projecting the wind deficits for the neighboring farms comprises:
superposing a plurality of wind deficits for the neighboring farms to generate a superposed wind deficit.

12. The non-transitory computer readable medium of claim 11, further comprising:
generating a predicted velocity field based on the superposed wind deficit.

13. The non-transitory computer readable medium of claim 12, wherein determining, by the computing system, the estimated power output for the wind farms in the geographical region of interest comprises:
applying turbine power curves to the predicted velocity field to generate the estimated power output.

14. The non-transitory computer readable medium of claim 8, wherein the information associated with the wind farms comprises one or more of height information, rotor diameter, nominal power, farm size, shape, position, turbine density and layout.

15. A system, comprising:
a processor; and
a memory having programming instructions stored thereon, which, when executed by the processor, causes the system to perform operations comprising:
identifying a geographical region of interest;
generating a background numerical weather prediction using a mesoscale numerical weather prediction model, the background numerical weather prediction illustrating a weather prediction for the geographical region of interest without any wind farms;
identifying information associated with wind farms for inclusion in the geographical region of interest, the information comprising coordinates associated each wind farm and turbine information associated with each wind farm;
for each wind farm, determining a wake effect of neighboring farms to the wind farm by projecting wind deficits for the neighboring farms to generate a plurality of wake effects for the geographical region; and
generating an estimated power output for the geographical region of interest based on the plurality of wake effects.

16. The system of claim 15, wherein determining the wake effect of the neighboring farms to the wind farm by projecting the wind deficits for the neighboring farms comprises:
for each neighboring farm, inputting a subset of information associated with the neighboring farm and the background numerical weather prediction into a neural network trained to generated wind deficits for the neighboring farm.

17. The system of claim 16, wherein projecting the wind deficits for the neighboring farms comprises:
superposing a plurality of wind deficits for the neighboring farms to generate a superposed wind deficit.

18. The system of claim 17, further comprising:
generating a predicted velocity field based on the superposed wind deficit.

19. The system of claim 18, wherein determining the estimated power output for the wind farms in the geographical region of interest comprises:
applying turbine power curves to the predicted velocity field to generate the estimated power output.

20. The system of claim 15, wherein the information associated with the wind farms comprises one or more of height information, rotor diameter, nominal power, farm size, shape, position, turbine density and layout.
